(19) United States
(12) Patent Application Publication
(10) Pub. No.: US 2026/0067312 A1
(43) Pub. Date: Mar. 5, 2026

(54) INTRUSION DETECTION SYSTEM AND METHOD WITH LOW COMPLEXITY AND BASED ON CNN IN VEHICLE NETWORK

(71) Applicant: Foundation of Soongsil University-Industry Cooperation, Seoul (KR)

(72) Inventors: Seongsoo Lee, Seoul (KR); Hyungchul Im, Incheon (KR)

(73) Assignee: Foundation of Soongsil University-Industry Cooperation, Seoul (KR)

(21) Appl. No.: 19/314,078

(22) Filed: Aug. 29, 2025

(30) Foreign Application Priority Data
Aug. 30, 2024 (KR) 10-2024-0117602

(51) Int. Cl. H04L 9/40

(52) U.S. Cl. CPC H04L 63/1425; H04L 63/1416

(57) ABSTRACT

An intrusion detection method performed by a convolutional neural network (CNN)-based intrusion detection system includes receiving in-vehicle CAN data in units of frame, generating first feature information by extracting multiple CAN IDs from the in-vehicle CAN data in units of frame and performing zero padding, generating second feature information by extracting a data region of a last frame received from the in-vehicle CAN data and performing the zero padding, training a CNN learning model by inputting the first feature information and the second feature information to the CNN learning model by using a sigmoid function, and detecting whether the in-vehicle CAN data is normal data or attack data by extracting the CAN ID and the data region from the received in-vehicle CAN data upon completion of the training of the CNN learning model and inputting the extracted CAN ID and the data region to the CNN learning model.

### CROSS-REFERENCE TO RELATED APPLICATION

This application is based on and claims priority under 35 U.S.C. § 119 to Korean Patent Application No. 10-2024-0117602, filed on Aug. 30, 2024, in the Korean Intellectual Property Office, the disclosure of which is incorporated by reference herein in its entirety.

### BACKGROUND

### 1. Field

The present disclosure relates to an intrusion detection system and method with low complexity and based on a convolutional neural network (CNN) in a vehicle network, and more specifically, to an intrusion detection system and method based on CNN which increases attack data detection performance and reduces complexity.

### 2. Description of the Related Art

With the recent increase in application of electronic control units (ECUs) in the automotive industry and the development of technologies such as Vehicle-2-Vehicle (V2V) and Vehicle-2-Infrastructure (V2I), potential cyberattacks on vehicles are on the rise. In an in-vehicle network (IVN), controller area network (CAN) communication is the most widely used because the CAN transmission efficiently manages data transmission between electronic control units and provides the flexibility for any node to initiate data transmission through a multi-master architecture.

However, CAN communication lacks security mechanisms such as message encryption or authentication, and accordingly, the CAN communication is vulnerable to attack. Therefore, an attacker may easily inject manipulated messages from both the inside and outside of a vehicle and control the vehicle without a driver's intent. Such vulnerability of CAN communication may lead to extremely dangerous situations during drive, and accordingly, it is essential to monitor in-vehicle systems and detect attacks.

To this end, research on an intrusion detection system (IDS) for various CAN communication protocols has been conducted in recent years. This suggests an increase in importance of developing robust security solutions to ensure the cybersecurity of modern vehicles. Various intrusion detection systems (IDS's) for CAN communication have been proposed and include fingerprint-based IDS, statistics-based IDS, and machine learning-based IDS.

The fingerprint-based IDS detects an attack by identifying a unique hardware fingerprint of each of different ECUs due to physical characteristics. Also, a clock-skew-based IDS, which is CIDS for setting a fingerprint based on a skew on an actual clock frequency and a reference clock to identify attackers, has been proposed. Also, Clock IDS which may set a unique fingerprint for each ECU, Viden which detects an attack based on electrical signal characteristics of each ECU, Voltage IDS which combines time-domain and frequency-domain characteristics of a voltage signal with machine learning, and so on have been proposed.

However, automotive network intrusion detection systems (IDS) require higher reliability and accuracy than general networks, such as consumer networks. For the reasons, a supervision learning-based IDS is more suitable as an IVN IDS than an unsupervised learning-based IDS. In a vehicular environment where safety has to be considered primarily, an IDS operates directly inside a vehicle, rather than outside, to detect attack in real time. Also, when considering limited computing resources of a vehicle, an IVN IDS has to operate efficiently with a low computational load.

The technology that is the background of the present disclosure is disclosed in Korean Patent No. 10-1638613 (published on Jul. 11, 2016).

### SUMMARY

The present disclosure provides an intrusion detection system and method with low complexity and based on CNN in vehicle network that increases attack detection performance and reduces complexity.

Additional aspects will be set forth in part in the description which follows and, in part, will be apparent from the description, or may be learned by practice of the presented embodiments of the disclosure.

According to an aspect of the present disclosure, an intrusion detection method performed by a convolutional neural network (CNN)-based intrusion detection system includes receiving in-vehicle CAN data in units of frame, generating first feature information by extracting multiple CAN IDs from the in-vehicle CAN data in units of frame and performing zero padding, generating second feature information by extracting a data region of a last frame received from the in-vehicle CAN data and performing the zero padding, training a CNN learning model by inputting the first feature information and the second feature information to the CNN learning model by using a sigmoid function, and detecting whether the in-vehicle CAN data is normal data or attack data by extracting the CAN ID and the data region from the received in-vehicle CAN data upon completion of the training of the CNN learning model and inputting the extracted CAN ID and the data region to the CNN learning model.

The CAN ID may include 29 bits, and the data region may include 0 to 64 bits.

The generating of the first feature information may include extracting n CAN IDs from n frames which are recently received, performing the zero padding to 29 bits when the CAN IDs are less than 29 bits, and merging the n CAN IDs in units of row to generate the first feature information including an n×29×1 binary image.

The generating of the second feature information may include extracting a data region from a last n^{th} frame which is most recently received, performing the zero padding to 64 bits when the data region is less than 64 bits, and merging the CAN IDs of respective frames in units of row to generate the second feature information including an 8×8×1 binary image.

The training of the CNN learning model may include performing labeling based on whether an n^{th} frame is attack data or normal data by using a data region of the n^{th} frame which is most recently received, setting the first and second feature information obtained from the n^{th} frame as input data, and setting a result of the labeling of the n^{th} frame as output data.

The training of the CNN learning model may further include inputting the first feature information to a 2×2 convolution and inputting the second feature information to a 3×3 convolution, combining the first feature information and the second feature information which pass through 2×2 max pooling and dense processes and applying the combined information to a sigmoid function, and training the CNN learning model by using a labeling result of a last frame and a sigmoid output value.

The n may be an odd number.

The n may be 7.

According to another aspect of the present disclosure, An intrusion detection system based on a convolutional neural network (CNN) in a vehicle network includes an input unit configured to receive in-vehicle CAN data in units of frame, a controller configured to generate first feature information by extracting multiple CAN IDs from the in-vehicle CAN data in units of frame and performing zero padding and generate second feature information by extracting a data region of a last frame received from the in-vehicle CAN data and performing the zero padding, a learning unit configured to train a CNN learning model by inputting the first feature information and the second feature information to the CNN learning model by using a sigmoid function, and a detector configured to detect whether the in-vehicle CAN data is normal data or attack data by extracting the CAN ID and the data region from the received in-vehicle CAN data upon completion of the training of the CNN learning model and inputting the extracted CAN ID and the data region to the CNN learning model.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a configuration diagram of a convolutional neural network (CNN)-based vehicle intrusion detection system according to an embodiment of the present disclosure;

FIG. 2 is a flowchart illustrating a CNN-based vehicle intrusion detection method according to an embodiment of the present disclosure;

FIG. 3 is a diagram illustrating a structure of a controller area network (CAN) data frame;

FIG. 4 is a diagram illustrating step S220 and step S230 of FIG. 2;

FIG. 5 is a diagram illustrating step S240 of FIG. 2;

FIG. 6 illustrates detection accuracy for each type of attack data according to a length of a CAN ID sequence; and

FIG. 7 illustrates detection accuracy for each type of attack data measured while varying a length of a CAN ID sequence in units of odd number.

### DETAILED DESCRIPTION

Hereinafter, embodiments of the present disclosure will be described in detail with reference to the attached drawings such that those skilled in the art may easily practice the disclosure. However, the present disclosure may be implemented in various different forms and is not limited to the embodiments described herein. In addition, for the purpose of clearly describing the present disclosure, parts irrelevant to the description are omitted in the drawings, and similar parts are designated with similar reference numerals throughout the specification.

Throughout the specification, when a part is said to be “connected” to another part, this includes not only a case where the part is “directly connected,” but also a case where the part is “electrically connected” with another element intervening therebetween. Furthermore, when a part is said to “include” a component, this does not exclude other components, but rather includes other components, unless otherwise specified.

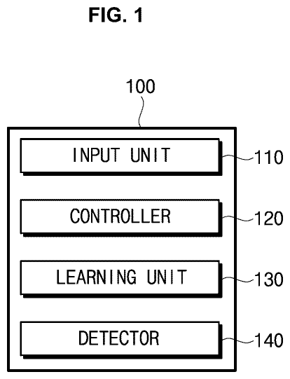

FIG. 1 is a configuration diagram of a convolutional neural network (CNN)-based vehicle intrusion detection system according to an embodiment of the present disclosure.

As illustrated in FIG. 1, a CNN-based vehicle intrusion detection system 100 according to an embodiment of the present disclosure includes an input unit 110, a controller 120, a learning unit 130, and a detector 140.

First, the input unit 110 receives in-vehicle controller area network (CAN) data in units of frame.

Next, the controller 120 generates first feature information by extracting multiple CAN IDs from the in-vehicle CAN data in units of frame and performing zero padding, and generates second feature information by extracting a data region of the most recently received frame and performing the zero padding.

Next, the learning unit 130 trains a CNN learning model including a sigmoid function by inputting the first and second feature information to the CNN learning model.

Finally, when training the CNN learning model is completed, the detector 140 extracts a CAN ID and data region from the received vehicle CAN data and inputs the CAN ID and data region to the trained CNN learning model to detect in real time whether the received CAN data is normal data or attack data.

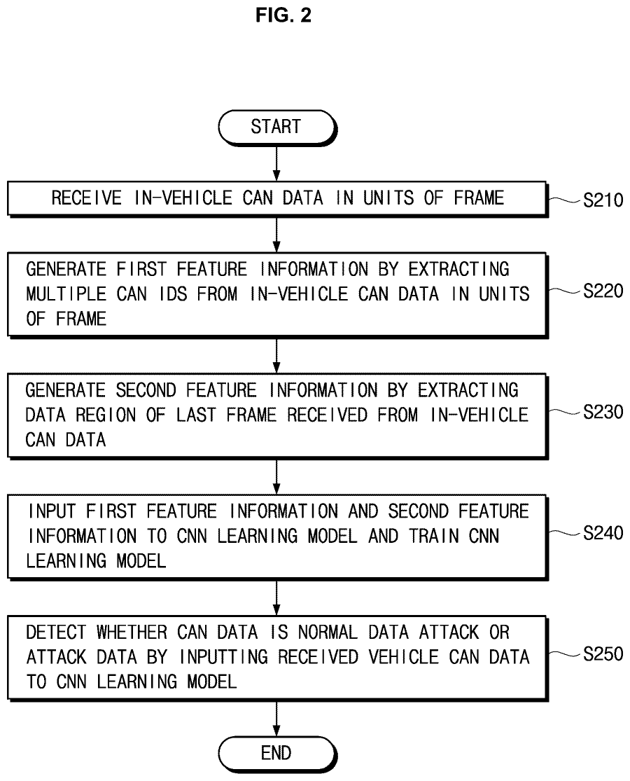

Hereinafter, a CNN-based vehicle intrusion detection method according to an embodiment of the present disclosure will be described with reference to FIGS. 2 to 7.

FIG. 2 is a flowchart illustrating the CNN-based vehicle intrusion detection method according to the embodiment of the present disclosure.

A CNN-based low complexity intrusion detection system (LC-IDS) for a vehicle, according to an embodiment of the present disclosure, includes step S210 to step S240 of training a CNN learning model and step S250 of detecting attack data in an actual CAN bus by using the trained model.

This structure is similar to a general deep learning-based intrusion detection system (IDS), but a method according to an embodiment of the present disclosure enables real-time detection by determining whether there is an attack in units of frame, and reduces complexity so as to be applied even in a resource-constrained environment.

First, through step S210 to step S240, a feature extraction and data preprocessing method used for a learning model according to an embodiment of the present disclosure is described, and a method of designing a CNN learning model with low complexity.

First, the input unit 110 receives in-vehicle CAN data in units of frame for training (S210).

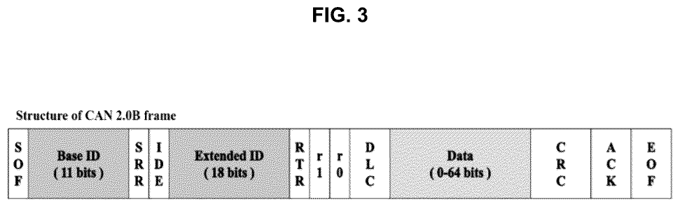

FIG. 3 is a diagram illustrating a structure of a CAN data frame.

As illustrated in FIG. 3, an identification (ID) of the CAN data frame is divided into a base ID and an extended ID. Here, the base ID is composed of 11 bits, and the extended ID is composed of 18 bits.

Accordingly, the ID of the CAN data frame is composed of 29 bits in total.

In addition, data of the CAN data frame is composed of 0 to 64 bits.

Next, the controller 120 generates first feature information by extracting a CAN ID from the in-vehicle CAN data in units of frames and performing zero padding (S220).

That is, the controller 120 extracts n CAN IDs from n frames which are recently received, and performs zero padding with 29 bits when each of the CAN IDs is less than 29 bits. In addition, the controller 120 merges the n CAN IDs in units of row and generates first feature information composed of an n×29×1 binary image.

In addition, the controller 120 generates second feature information by extracting data of the most recently received last frame and performing zero padding (S230).

That is, the controller 120 extracts data from the n^{th} frame which is most recently received, and performs zero padding with 64 bits when the data is less than 64 bits. In addition, the controller 120 merges the CAN IDs of each frame in units of row and generates the second feature information composed of an 8×8×1 binary image.

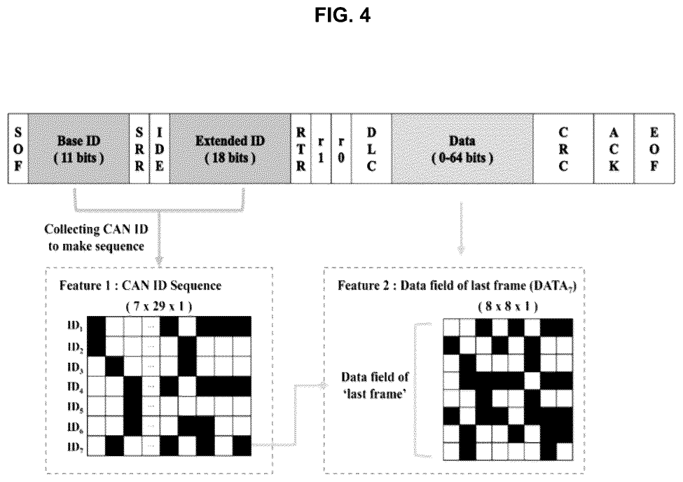

FIG. 4 is a diagram illustrating step S220 and step S230 of FIG. 2.

Step S220 and step S230 are described in more detail with reference to FIG. 4. According to an embodiment of the present disclosure, a pattern of the CAN ID generated on a CAN bus and data of the last received frame are each used as feature information to train a CNN learning model.

Here, the last frame refers to the CAN frame which is most recently received through a CAN bus. Therefore, the trained CNN learning model determined whether there is abnormality, based on first feature information according to a CAN ID sequence and second feature information on the data of the most recently generated CAN frame within the sequence.

According to an embodiment of the present disclosure, it is possible to simultaneously learn CAN ID sequence information and determine whether the current CAN frame is attack data, and accordingly, attack may be detected in units of frame, and detection may be made real-time. Therefore, according to an embodiment of the present disclosure, the vehicle intrusion detection system 100 extracts a CAN ID pattern and data of the final frame by using a sliding window method when training data.

Therefore, the feature information of learning data includes first feature information corresponding to a CAN ID sequence Feature_{n,1} and second feature information corresponding to the data of a CAN frame.

For example, feature information of the first learning data includes a CAN ID sequence (Feature_{1,1}=ID₁, ID₂, ID₃, . . . , IDₙ) corresponding to the first feature information and (Feature_{2,1}=DATAₙ) corresponding to the second feature information, and a corresponding label is determined based on data of an n^{th} CAN frame which is most recently received.

Likewise, feature information of the second learning data includes an ID sequence (Feature_{1,2}=ID₂, ID₃, ID₄, . . . , IDₙ₊₁) corresponding to the first feature information and (Feature_{2,2}=DATAₙ₊₁) corresponding to the second feature information, and a label is determined based on data of the n+1^{th} CAN frame.

Preferably, CAN IDs are extracted respectively from seven frames which have been received recently, and labels of attack data and normal data are determined based on the data included in the seventh frame which is received last.

In this way, the first feature information Feature₁, which is composed of the CAN ID sequence, is converted into a binary image having a size of n×29×1 in consideration of an ID of maximum 29 bits in the CAN frame. When the ID is less than 29 bits, the controller 120 performs a zero-padding process of filling the other bits with 0.

The second feature information Feature₂ corresponding to the data also has data of up to 64 bits in the CAN frame, and the controller 120 converts the second feature information into a binary image having a size of 8×8×1 and performs a zero padding process of filling the second feature information with 0 when the ID is less than 64 bits.

Next, the learning unit 130 inputs the first and second feature information to a CNN learning model including a sigmoid function and trains the learning model (S240).

An actual vehicle requires an intrusion detection model that may be applied to an environment with limited computing performance and a limited memory size, and accordingly, an embodiment of the present disclosure proposes a structure of a CNN learning model with low complexity which is illustrated in FIG. 4.

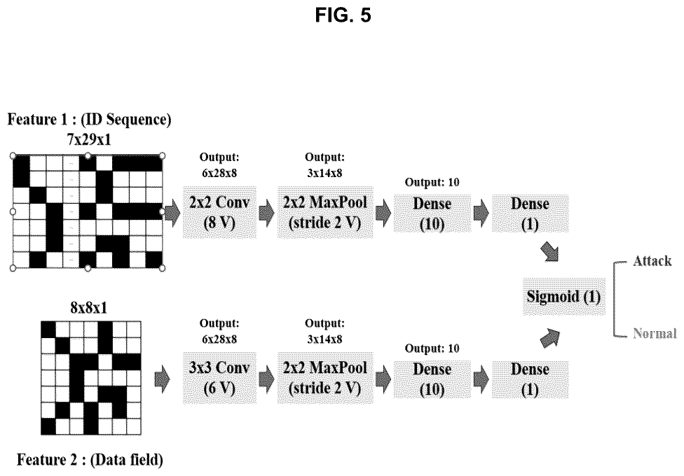

FIG. 5 is a diagram illustrating step S240 of FIG. 2.

First, the learning unit 130 performs CNN training on a preprocessed CAN ID sequence corresponding to the first feature information and data of the last frame corresponding to the second feature information.

In this case, the learning unit 130 inputs the first feature information to a 2×2 convolution and inputs the second feature information to a 3×3 convolution.

Next, the learning unit 130 adds a 2×2 MaxPooling layer to reduce a network computational burden and improve generalization capability. In this process, only the first and second features which are the most prominent information representing features of a CAN frame are selected such that a CNN learning model focuses on important information.

An output of a MaxPooling layer is flattened and connected to a fully connected (FC) layer, and FC layers are finally combined together through concatenation. In this process, the important first and second features are efficiently extracted and connected from the CAN ID sequence and the last frame.

The CNN learning model uses two binary images on the first and second feature information as input data and sets labels on the attack data or normal data in the last frame as output data.

This may be represented by Equation 1 below as a function.

$$y = f ( {x}_{1} , {x}_{2} , θ ) \qquad Equation 1$$

Here, y is an output label indicating whether the input CAN data is normal data or attack data, x₁ and x₂ respectively represent the first feature information Feature₁ and the second feature information Feature₂, θ is a parameter of a CNN learning model, and f is a function representing the CNN learning model of an intrusion detection system.

Therefore, the learning unit 130 trains the CNN learning model by using the labeling result of the last frame of CAN data and a sigmoid output value.

In this way, when training the CNN learning model is completed, the detector 140 extracts a CAN ID and data region from the received vehicle CAN data and inputs the CAN ID and data region to the CNN learning model to detect whether the CAN data is normal data or attack data (S250).

Each configuration of step S250 is substantially the same as step S210 to step S240 except for training and test processes, and accordingly, redundant descriptions thereof are omitted.

Hereinafter, the complexity of a CNN-based vehicle intrusion detection system according to an embodiment of the present disclosure will be described.

Calculating floating point operations per second (FLOPs) is an important indicator for evaluating the complexity of a learning model. FLOPs represent the total number of floating-point operations performed by a model, and therethrough, a model's calculation efficiency and the scale of necessary computing resources may be evaluated. Therefore, FLOPs are used as a key indicator for evaluating whether a CNN learning model is suitable for real-time application or may be efficiently executed on limited hardware resources.

In a CNN operation, FLOPs may be calculated by considering various factors such as a filter size (kₕ×k_{w}), the number of filters K_{c}, dimensionality of input data I_{c}, and a size of an output feature map (Oₕ×O_{w}). This is represented by Equation 2 below.

$${FLOP}_{{S}_{CNN}} = {k}_{h} \times {k}_{w} \times {C}_{in} \times {C}_{out} \times {O}_{h} \times {O}_{w} \qquad Equation 2$$

Here, subscripts h, w, and c respectively represent a height, a width, and a channel. Generally, the complexity of a CNN learning model is mainly determined by the CNN operation. Therefore, an output (Oₕ×O_{w}) after the CNN operation has to be as small as possible, as represented by Equation 3 and Equation 4 below.

$$\begin{matrix}{O}_{h} = \frac{{I}_{h} + 2 {p}_{h} - {k}_{h}}{s} + 1 & Equation 3 \\ {O}_{w} = \frac{{I}_{w} + 2 {p}_{w} - {k}_{w}}{s} + 1 & Equation 4\end{matrix}$$

Here, pₕ and pw represent the amount of zero padding at an edge of the input feature map, and S represents a stride.

Calculating the FLOPs of an FC layer is an essential part of evaluating the entire complexity of a model. In the FC layer, all neurons are interconnected between an input and an output, and calculation on this layer is primarily based on an inner product of a weight and an input vector. Therefore, FLOPs of the FC layer may be calculated by considering input and output sizes, as represented by Equation 5.

$${FLOP}_{{S}_{FC}} = {U}_{in} \times {U}_{out} \qquad Equation 5$$

Here, Uᵢₙ and Uₒᵤₜ respectively represent the size of an input to an FC layer and the size of an output generated by a corresponding layer. Finally, a MaxPooling layer and an activation function account for a small portion of the entire network operation, calculation of FLOPs is omitted.

Below, a dataset used for experimental examples and indicators used for model performance evaluation are described to evaluate complexity of the present disclosure. Finally, experimental results are compared with the known models in terms of performance and complexity.

### EXPERIMENTAL EXAMPLE

An open car hacking dataset was used for an experimental example of the present disclosure, which is widely used in vehicle security research. The dataset was generated by recording CAN traffic through an OBD-II port of an actual vehicle and includes four types of attacks: DoS attack, fuzzy attack, spoofing attack (RPM), and spoofing attack (Gear). These are shown in Table 1 below.

TABLE 1

| Dataset | Normal Messages | Attack Messages |
|---|---|---|
| DoS Attack | 3,078,250 | 587,521 |
| Fuzzy Attack | 3,347,013 | 491,847 |
| Spoofing Attack (Gear) | 3,845,890 | 597,252 |
| Spoofing Attack (RPM) | 3,966,805 | 654,897 |

The DOS attack occupies a CAN bus with a high-priority message ID, such as “0x00”, thereby disrupting the transmission of a CAN frame having a low priority message ID, and the fuzzy attack occupies a bus or causes ECU malfunction. Furthermore, the spoofing attack induces malfunction by injecting a CAN frame having a CAN ID associated with a certain device, such as engine RPM and drive gear.

For the experiment, the dataset was divided into training, testing, and validation sets in a 7:2:1 ratio. All training sets were combined during training, and all validation sets were combined during validation. During testing, each test was used separately to evaluate a model's performance.

The performance of a CNN learning model according to the present disclosure was evaluated by using accuracy, precision, recall, and F1-score. Each attack frame within the dataset is considered to be positive, and a normal frame is considered to be negative. Metrics are calculated by using Equation 6 to Equation 9 below.

$$\begin{matrix}Accuracy = \frac{TP + TN}{TP + FP + FN + TN} & Equation 6 \\ Precision = \frac{TP}{TP + FP} & Equation 7 \\ Recall = \frac{TP}{TP + FN} & Equation 8 \\ F 1 - score = \frac{2 \cdot Recall \cdot Precision}{Recall + Precision} & Equation 9\end{matrix}$$

Here, true positive (TP) represents a correctly classified attack frame, and true negative (TN) represents a correctly classified normal frame. False positive (FP) represents a normal frame classified as an attack, and false negative (FN) represents an attack frame classified as normal.

In the experimental example of the present disclosure, the filter size was set to 2×2 to reduce complexity by considering Equation 2. Also, padding was not used according to Equation 3 and Equation 4, and a stride was set to 1. When a stride size increases, an output size is reduced, which may reduce FLOPs. However, due to a limited size of input data, there is a possibility of losing necessary training information. Therefore, the size of a MaxPooling layer was also set to 2×2 to extract more information. According to Equation 2, the output size significantly affects FLOPs depending on an input format, and accordingly, it is important to determine an appropriate length of an ID sequence.

When a length of the ID sequence is even-numbered, an output after CNN operation will be odd number×even number, and in this case, the last row will be omitted during MaxPooling, and accordingly, performance may be degraded.

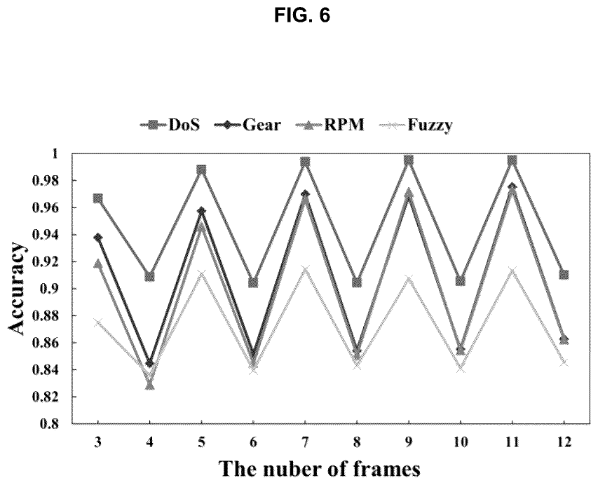

In order to check this effect, accuracies of the lengths of CAN ID sequences are compared with each other, excluding the data Feature₂ corresponding to the second feature information, and the comparison results are illustrated in FIG. 6.

FIG. 6 illustrates detection accuracy for each attack data type depending on lengths of CAN ID sequences.

As illustrated in FIG. 6, there is a significant difference in detection performance when the length of a CAN ID sequence is an odd number and an even number. This suggests that the information of the last row of an output after a CNN operation is important because labeling is performed based on the last frame during model training.

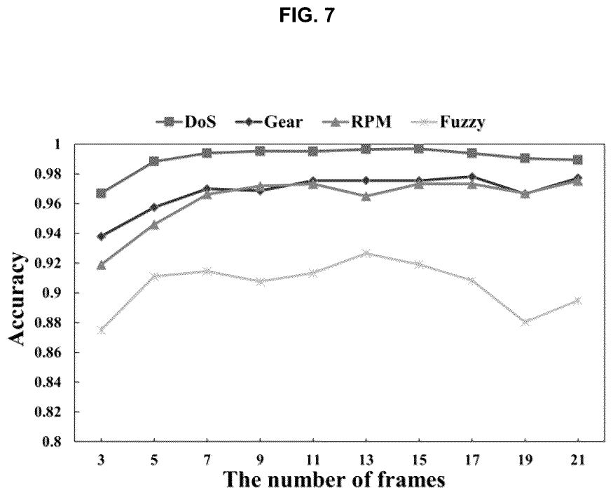

FIG. 7 illustrates the detection accuracy for each attack data type measured while varying the length of a CAN ID sequence length in units of odd number.

That is, FIG. 7 illustrates a result of comparing accuracy while adjusting the length of the CAN ID sequence to determine the lengths of an appropriate odd-numbered CAN ID sequences, that is, the number of frames. When the lengths of the CAN ID sequences increase to 7, detection accuracies of all attack types increase, and thereafter, detection performance saturates even when the lengths of the CAN ID sequences increase. Therefore, in the embodiment of the present disclosure, a length n of a CAN ID sequence is set to 7.

In the experimental example of the present disclosure, when trained Feature₂ corresponding to the second feature information, a 3×3 filter was used for the CNN operation, unlike when trained Features corresponding to the first feature information. This relates to the fixed 8×8 input shape of Feature₂.

Using a 2×2 filter results in a 7×7 output size, and thereafter, applying 2×2 MaxPooling results in data loss. Table 2 below shows the attack detection performance of a model trained by using only the first feature information Feature₁ or the second feature information Feature₂ using a 3×3 filter in the operation and the attack detection performance of a CNN learning model, according to the present disclosure, which is trained by using both the first and second feature information.

TABLE 2

| Metrics | Feature | DoS Attack | Fuzzy Attack | Gear Attack | RPM Attack |
|---|---|---|---|---|---|
| Precision | Feature₁ (ID) | 98.12 | 79.93 | 90.49 | 89.03 |
| | Feature₂ (Data) | 89.54 | 84.12 | 78.39 | 79.17 |
| | Both (ID&Data) | 100 | 99.99 | 100 | 100 |
| Recall | Feature₁ (ID) | 98.96 | 69.36 | 91.70 | 92.44 |
| | Feature₂ (Data) | 100 | 99.94 | 100 | 100 |
| | Both (ID&Data) | 100 | 99.97 | 100 | 100 |

Table 2 shows that other learning models, which are trained by using only a CAN ID sequence or data, exhibit some limitations in performance. In contrast to this, the CNN learning model according to the embodiment of the present disclosure achieves near-perfect detection performance by being trained by using both the ID sequence and data features.

Table 3 shows a result of comparing the detection performance of a low-complexity intrusion detection system (LC-IDS) according to an embodiment of the present disclosure with the detection performance of general IDS models.

TABLE 3

| Antack Type | Models | Accuracy | Precision | Recall | F1-score |
|---|---|---|---|---|---|
| DoS Attack | DONN | 99.97 | 100 | 99.88 | 99.95 |
| | NovelADS | — | 99.97 | 99.91 | 99.94 |
| | HyDL-IDS | 100 | 100 | 100 | 100 |
| | QMLP-IDS | 99.97 | 99.92 | 100 | 99.96 |
| | LC-IDS | 100 | 100 | 100 | 100 |
| Fuzzy Attack | DCNN | 99.82 | 99.95 | 99.65 | 99.80 |
| | NovelADS | — | 99.99 | 100 | 100 |
| | HyDL-IDS | 99.98 | 99.99 | 99.89 | 99.94 |
| | QMLP-IDS | 99.89 | 99.86 | 99.67 | 99.76 |
| | LC-IDS | 99.99 | 99.99 | 99.97 | 99.98 |
| Gear Attack | DCNN | 99.95 | 99.99 | 99.89 | 99.96 |
| | NovelADS | — | 99.89 | 99.93 | 99.91 |
| | HyDL-IDS | 100 | 100 | 100 | 100 |
| | QMLP-IDS | 99.89 | 99.90 | 100 | 99.95 |
| | LC-IDS | 100 | 100 | 100 | 100 |
| RPM Attack | DCNN | 99.97 | 99.99 | 99.94 | 99.96 |
| | NovelADS | — | 99.91 | 99.90 | 99.91 |
| | HyDL-IDS | 100 | 100 | 100 | 100 |
| | QMLP-IDS | 100 | 100 | 100 | 100 |
| | LC-IDS | 100 | 100 | 100 | 100 |

Table 3 shows that the low-complexity intrusion detection system (LC-IDS) according to the present disclosure has detection performance similar to or better than the detection performance of the other learning models.

Table 4 also shows a result of calculating FLOPs and the number of parameters of respective models.

TABLE 4

| Models | FLOPs | Parameters |
|---|---|---|
| DCNN | 101.13M | 1.70M |
| NovelADS | 36.457M | 0.371M |
| HyDL-IDS | 0.128M | 0.122M |
| QMLP-IDS | 0.157M | 0.108M |
| LC-IDS | 11.242 | 4.045 |

As shown in Table 4, a DCNN model is trained in units of 29 frames and classifies that there is an attack when any of the 29 frames includes an attack. Therefore, there is a disadvantage that it is not clear exactly which frame is an attack.

Likewise, NovelADS based on unsupervised learning has an advantage of being able to detect an untrained attack, but has the same problem because of being trained in units of 100 frames. Also, this model requires different thresholds for each attack type, resulting in reduction in efficiency. Like the LC-IDS, HyDL-IDS and QMLP-IDS models are based on the supervised learning, thereby being able to detect an attack in units of frame. However, the LC-IDS proposed by the present disclosure demonstrates superior performance compared to other models.

When comparing FLOPs with parameters in Table 4, the low-complexity intrusion detection system (LC-IDS) corresponding to the embodiment of the present disclosure demonstrates lower complexity and memory usage than other models. In particular, the DCNN model and NovelADS have relatively high FLOPs and parameter counts, making both models difficult to apply in resource-limited environments.

Also, the low-complexity intrusion detection system (LC-IDS) corresponding to the experimental example of the present disclosure requires only 10% and 3.3% of the CNN-LSTM model in FLOPs and parameter counts, respectively, and requires approximately 7.2% and 3.7% of the QMLP-IDS model in the FLOPs and parameter counts, respectively, and accordingly, the LC-IDS has lower complexity than the other learning models.

Also, the LC-IDS according to the embodiment of the present disclosure has a simple structure and small size, and accordingly, the time required to detect attack data may be reduced.

In this way, according to the embodiment of the present disclosure, attack data may be detected more accurately by applying feature information of a CAN ID sequence and a data region of a specific CAN frame to a CNN learning model. Also, complexity may be significantly reduced by inputting CAN ID sequence feature information to a 2×2 convolution, inputting CAN frame data feature information to a 3×3 convolution, and then performing 2×2 max pooling on each.

While the present disclosure is described with reference to the embodiments illustrated in the drawings, these are merely examples, and those skilled in the art will understand that various modifications and equivalent other embodiments may be derived therefrom. Therefore, the true technical protection scope of the present disclosure should be determined by the technical idea of the appended claims.

What is claimed is:

1. An intrusion detection method performed by a convolutional neural network (CNN)-based intrusion detection system, the intrusion detection method comprising:
receiving in-vehicle CAN data in units of frame;
generating first feature information by extracting multiple CAN IDs from the in-vehicle CAN data in units of frame and performing zero padding;
generating second feature information by extracting a data region of a last frame received from the in-vehicle CAN data and performing the zero padding;
training a CNN learning model by inputting the first feature information and the second feature information to the CNN learning model by using a sigmoid function; and
detecting whether the in-vehicle CAN data is normal data or attack data by extracting the CAN ID and the data region from the received in-vehicle CAN data upon completion of the training of the CNN learning model and inputting the extracted CAN ID and the data region to the CNN learning model.

2. The intrusion detection method of claim 1, wherein
the CAN ID includes 29 bits, and
the data region includes 0 to 64 bits.

3. The intrusion detection method of claim 2, wherein
the generating of the first feature information includes extracting n CAN IDs from n frames which are recently received, performing the zero padding to 29 bits when the CAN IDs are less than 29 bits, and merging the n CAN IDs in units of row to generate the first feature information including an n×29×1 binary image.

4. The intrusion detection method of claim 2, wherein
the generating of the second feature information includes extracting a data region from a last n^{th} frame which is most recently received, performing the zero padding to 64 bits when the data region is less than 64 bits, and merging the CAN IDs of respective frames in units of row to generate the second feature information including an 8×8×1 binary image.

5. The intrusion detection method of claim 1, wherein
the training of the CNN learning model includes performing labeling based on whether an n^{th} frame is attack data or normal data by using a data region of the n^{th} frame which is most recently received, setting the first and second feature information obtained from the n^{th} frame as input data, and setting a result of the labeling of the n^{th} frame as output data.

6. The intrusion detection method of claim 5, wherein
the training of the CNN learning model further includes inputting the first feature information to a 2×2 convolution and inputting the second feature information to a 3×3 convolution, combining the first feature information and the second feature information which pass through 2×2 max pooling and dense processes and applying the combined information to a sigmoid function, and training the CNN learning model by using a labeling result of a last frame and a sigmoid output value.

7. The intrusion detection method of claim 3, wherein
the n is an odd number.

8. The intrusion detection method of claim 7, wherein
the n is 7.

9. An intrusion detection system based on a convolutional neural network (CNN) in a vehicle network, the intrusion detection system comprising:
an input unit configured to receive in-vehicle CAN data in units of frame;
a controller configured to generate first feature information by extracting multiple CAN IDs from the in-vehicle CAN data in units of frame and performing zero padding and generate second feature information by extracting a data region of a last frame received from the in-vehicle CAN data and performing the zero padding;
a learning unit configured to train a CNN learning model by inputting the first feature information and the second feature information to the CNN learning model by using a sigmoid function; and
a detector configured to detect whether the in-vehicle CAN data is normal data or attack data by extracting the CAN ID and the data region from the received in-vehicle CAN data upon completion of the training of the CNN learning model and inputting the extracted CAN ID and the data region to the CNN learning model.

10. The intrusion detection system of claim 9, wherein
the CAN ID includes 29 bits, and
the data region includes 0 to 64 bits.

11. The intrusion detection system of claim 10, wherein
the controller is further configured to extract n CAN IDs from n frames which are recently received, perform the zero padding to 29 bits when the CAN IDs are less than 29 bits, and merge the n CAN IDs in units of row to generate the first feature information including an n×29×1 binary image.

12. The intrusion detection system of claim 10, wherein
the controller is further configured to extract a data region from a last n^{th} frame which is most recently received, perform the zero padding to 64 bits when the data region is less than 64 bits, and merge the CAN IDs of respective frames in units of row to generate the second feature information including an 8×8×1 binary image.

13. The intrusion detection system of claim 9, wherein
the learning unit is further configured to perform labeling based on whether an n^{th} frame is attack data or normal data by using a data region of the n^{th} frame which is most recently received, set the first and second feature information obtained from the n^{th} frame as input data, and set a result of the labeling of the n^{th} frame as output data.

14. The intrusion detection system of claim 13, wherein
the learning unit is further configured to input the first feature information to a 2×2 convolution and inputting the second feature information to a 3×3 convolution, combine the first feature information and the second feature information which pass through 2×2 max pooling and dense processes and applying the combined information to a sigmoid function, and train the CNN learning model by using a labeling result of a last frame and a sigmoid output value.

15. The intrusion detection system of claim 11, wherein
the n is an odd number.

16. The intrusion detection system of claim 15, wherein
the n is 7.
